(19) United States
(12) Patent Application Publication
(10) Pub. No.: US 2019/0393009 A1
(43) Pub. Date: Dec. 26, 2019

(54) ELECTROMAGNETIC RELAY

(71) Applicant: FUJITSU COMPONENT LIMITED, Tokyo (JP)

(72) Inventors: Takuto Motohama, Tokyo (JP); Kazutaka Nagamine, Tokyo (JP)

(21) Appl. No.: 16/444,674

(22) Filed: Jun. 18, 2019

(30) Foreign Application Priority Data
Jun. 22, 2018 (JP) 2018-118942

(51) Int. Cl. H01H 50/30; H01H 50/04; H01H 50/54

(52) U.S. Cl. CPC H01H 50/30; H01H 50/54; H01H 50/041

(57) ABSTRACT

An electromagnetic relay includes a relay including an electromagnet, a contact which opens and closes in accordance with operation of the electromagnet, and an inner housing in which the electromagnet and the contact are accommodated, a support member on which the relay is elastically supported, an outer housing in which the relay is accommodated, and a weight which is attached to the relay.

This application claims the benefit of JP Application 2018-118942, filed Jun. 22, 2018, the entire contents of which is incorporated herein by reference.

### TECHNICAL FIELD

The present invention relates to an electromagnetic relay.

### BACKGROUND

Electromagnetic relays that reduce operation noise generated during operations are known (refer to Japanese Unexamined Utility Model Publication No. 61-90141 (JP S61-90141U) and Japanese Unexamined Patent Publication (Kokai) No. 2012-243510 (JP 2012-243510A)). JP S61-90141U describes reducing operation noise by surrounding the electromagnetic relay with a plastic which contains metal powder, or attaching metal plates to the components of the electromagnetic relay. JP 2012-243510A describes an electromagnetic relay comprising a body, a terminal which supports the body, a base which supports the terminal, and a cover. In JP 2012-243510A, the operation noise of the relay is absorbed by the terminal.

### SUMMARY

In recent years, the demand for silence in the passenger compartment is increasing against the backdrop of the popularization of hybrid vehicles and electric cars. Thus, there is an increasing demand for greater silence in the electromagnetic relays used in hybrid or electric vehicles, and an electromagnetic relay which can achieve quietness with a simple configuration and which is excellent in manufacturability has been demanded.

An aspect of the present disclosure provides an electromagnetic relay, comprising an relay including an electromagnet, a contact which opens and closes in accordance with operation of the electromagnet, and an inner housing in which the electromagnet and the contact are accommodated, a support member on which the relay is elastically supported, an outer housing in which the relay is accommodated, and a weight which is attached to the relay.

### BRIEF DESCRIPTION OF THE DRAWINGS

FIG. 1 is an external perspective view illustrating the electromagnetic relay according to an embodiment.

FIG. 2 is a perspective view illustrating the electromagnetic relay from which an outer cover has been removed.

FIG. 3 is an exploded perspective view of the electromagnetic relay.

FIG. 4 is a view detailing the propagation of vibration sounds in the electromagnetic relay.

FIG. 5 is an exploded view detailing the connection of a relay terminal and a relay.

FIG. 6 is an exploded view detailing the connection of the relay terminal and the relay.

FIG. 7 is an enlarged perspective view illustrating the relay terminal and base of FIG. 3.

FIG. 8 is a longitudinal sectional view illustrating the internal structure of the relay.

FIG. 9 is a view illustrating a vibration model of the electromagnetic relay.

FIG. 10 is a graph illustrating measurement results of operation noise generated when the electromagnets of the comparative relay and of the present embodiment are turned on.

FIG. 11 is a graph illustrating the measurement results of return noise generated when the electromagnets of the comparative relay and of the present embodiment are turned off.

FIG. 12 is a graph illustrating the measurement results of the sound pressure waveform of the comparative relay.

FIG. 13 is a graph illustrating the measurement results of the sound pressure waveform of the electromagnetic relay when a 3 g weight has been attached thereto.

FIGS. 14A to 14I are views illustrating arrangement examples of the weight in the space.

FIG. 15 is an exploded perspective view of the relay including a relay cover to which a weight can be attached.

FIG. 16 is a view detailing the assembly of the relay of FIG. 15.

FIG. 17 illustrates an example of the electromagnetic relay to which a weight is secured by thermal caulking.

FIG. 18 illustrates an electromagnetic relay in which the weight is secured by being fit into the relay cover.

FIG. 19 illustrates an electromagnetic relay in which the relay is secured by being fit into a U-shaped weight.

FIG. 20 is a perspective view of the weight of FIG. 19.

FIG. 21 illustrates an example of the electromagnetic relay in which the weight is adhered to the relay cover.

### DETAILED DESCRIPTION

The embodiments of the present disclosure will be described with reference to the drawings. In the drawings, identical portions are assigned the same reference numerals. For the ease of understanding, the scales of the drawings have been appropriately modified. The embodiments illustrated in the drawings are merely examples for carrying out the present invention. The present invention is not limited to the illustrated embodiments.

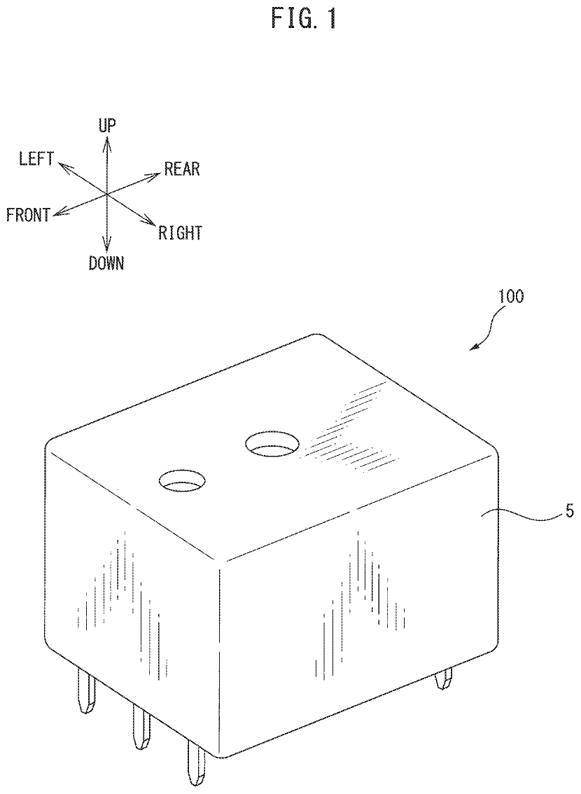

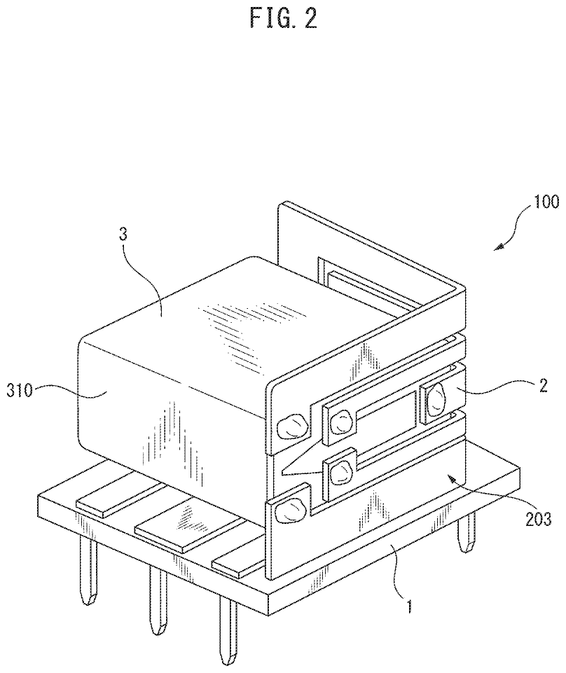

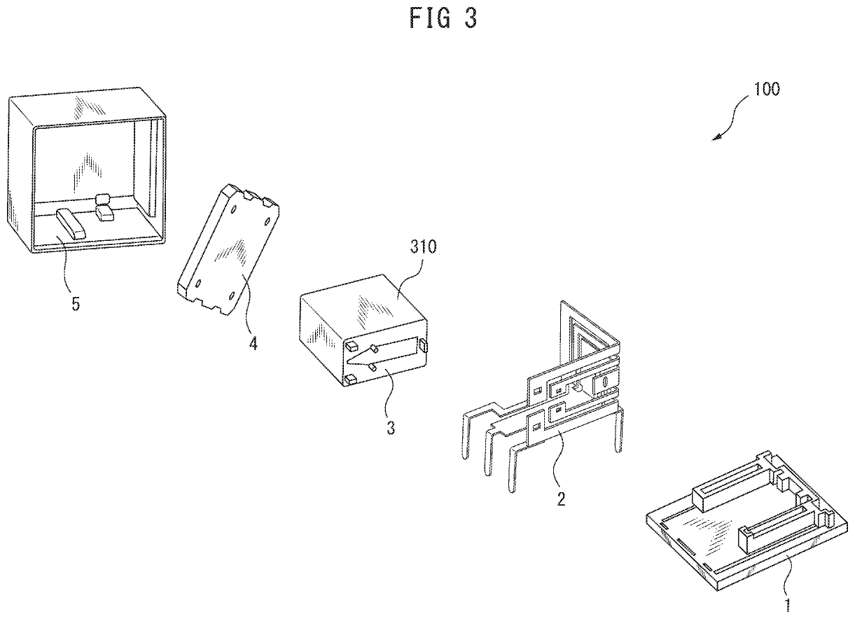

FIG. 1 is an external perspective view of an electromagnetic relay 100 according to an embodiment. FIG. 2 is a perspective view of the electromagnetic relay 100 from which an outer cover 5 has been removed. FIG. 3 is an exploded perspective view of the electromagnetic relay 100. As illustrated in FIGS. 1 to 3, the electromagnetic relay 100 comprises a base 1, a relay terminal 2 which is assembled with the base 1, a relay 3 which is connected to and supported by the relay terminal 2, a weight 4 for increasing the weight of the relay 3, and an outer cover 5. The electromagnetic relay 100 is mounted on a printed circuit board in the state illustrated in FIG. 1. For convenience of explanation below, the direction parallel to the longitudinal direction of the electromagnetic relay 100 is defined as the front-rear directions, and the left-right directions and up-down directions are defined as illustrated in FIG. 1 using the front-rear directions as a reference.

Though only a single weight 4 is illustrated in FIG. 3 for the sake of convenience, a plurality of weights 4 may be used. Specific examples related to the weight 4 (number, arrangement, shape, etc.) are described later. The material of the weight 4 is, for example, a metal such as iron.

The relay terminal 2 is a leaf-spring-shaped conductive member and is assembled with the base 1. The relay 3 is supported in a cantilever manner by the relay terminal 2 in a state in which it is connected to the electrodes of the right surface 203 of the relay terminal 2 by soldering. In other words, the relay 3 is in a floated state with respect to the base. The relay terminal 2 has sufficient rigidity so as to support the relay 3 in a cantilever manner. The relay terminal 2 serves as a terminal relaying between the electrodes of the relay 3 and the printed circuit board and serves to absorb vibration and shock occurring in the relay 3.

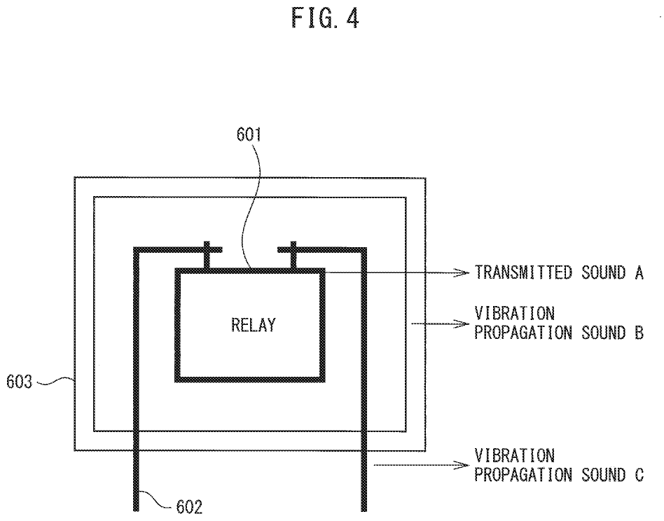

The electromagnetic relay 100 is configured so as to suppress vibration sounds and impact noise generated by the relay 3. The propagation of vibration sounds in an electromagnetic relay configured such that a base and a relay are assembled via a relay terminal and covered with an outer cover can be represented as illustrated in FIG. 4. In this case, the vibration sounds include transmitted sound A, which propagates directly from the relay 601 to the outside, vibration propagation sound B, which is generated by the vibration propagating from the relay 601 to the outer cover and base 603, and vibration propagation sound C in which vibration of the relay 601 propagates to the printed circuit board via the relay terminal 602, whereby the printed circuit board serves as a secondary noise source.

The electromagnetic relay 100 suppresses the transmitted sound A by adopting a two-cover configuration with an outer cover 5 and a relay cover 310, which are both resin-molded articles. The electromagnetic relay 100 suppresses the vibration propagation sound B and the vibration propagation sound C by connecting the relay 3 to the base 1 via the relay terminal 2. The electromagnetic relay 100 reduces the vibration propagation sound C by adopting the adhesive having elasticity, such as a urethane adhesive, for adhering the outer cover 5 to the base 1. In addition, the electromagnetic relay 100 is configured to use a weight 4 in order to further suppress overall vibration sounds and the like.

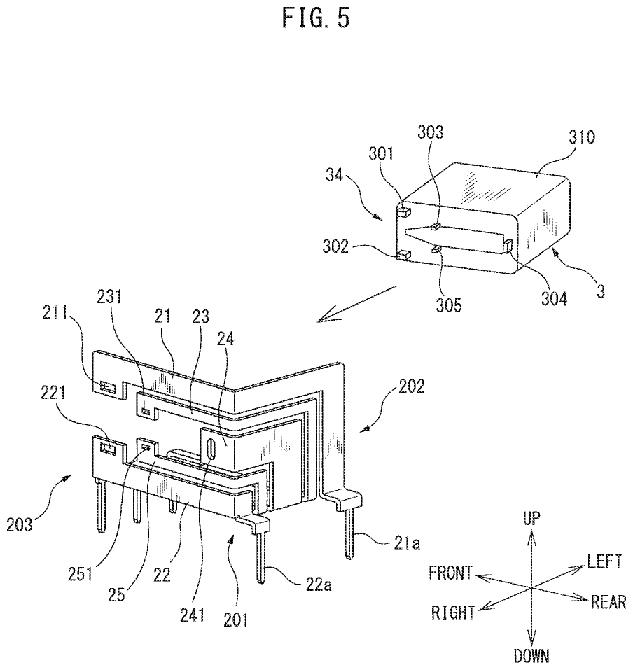

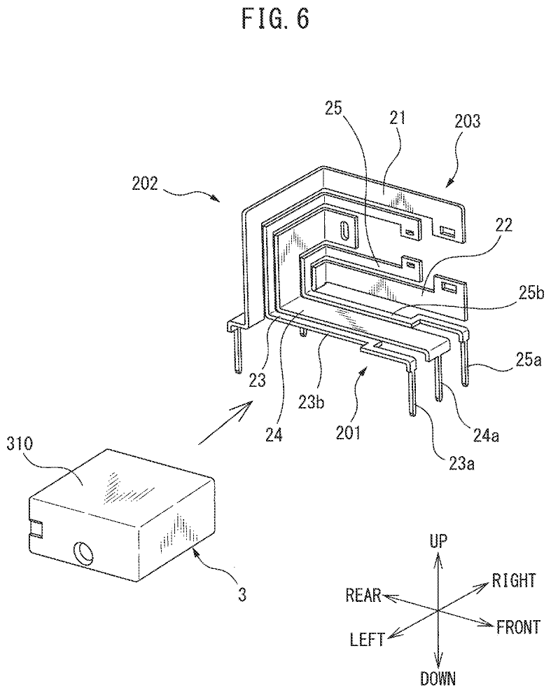

Next, the relay terminal 2 and the connection between the relay terminal 2 and the relay 3 will be described with reference to FIGS. 5 and 6. FIGS. 5 and 6 are exploded views detailing the connection between the relay terminal 2 and the relay 3. FIG. 5 is a perspective view illustrating the appearance of the outer surface of the relay terminal 2. FIG. 6 is a perspective view illustrating the appearance of the inner surface of the relay terminal 2. In FIGS. 5 and 6, the direction of attachment of the relay 3 is indicated by the arrow. The relay terminal 2 is a conductive plate member which is electrically connected to the relay 3, and includes mutually independent elongate first plate 21 to fifth plate 25 of which the number corresponds to the number of connection terminals of the relay 3 (five in the present embodiment). The connection part between the bottom surface 201 and the rear surface 202 and the connection part between the rear surface 202 and the right surface 203 are bent at 90° angles so that the five plates form the bottom surface 201, the rear surface 202, and the right surface 203.

The shapes of the plates 21 to 25 will be described in detail. The plates 21 to 25 extend parallel to each other in the front-rear directions at certain intervals in the up-down directions so as to form gaps between the adjacent plates 21 to 25 in the right surface 203. Further, after extending parallel with each other in the lateral direction at certain intervals in the rear surface 202, the plates 21 to 25 extend downwardly while maintaining the constant distances therebetween. The plates 21 to 25 do not contact each other, and form L-shapes in the rear surface 202. The widths of the plates 21 to 25 are determined in accordance with the type of terminals of the relay 3 to which the plates 21 to 25 are connected.

Among the plates 21 to 25, the first plate 21 and the second plate 22 are bent rearward at right angles at the lower ends thereof, and the third plate 23 to the fifth plate 25 are bent frontward at right angles at the lower ends thereof. The plates 21 to 25 after bending extend along the bottom surface 201 without contacting each other. The tips of the plates 21 to 25 are bent downward to form terminals 21a to 25a.

As illustrated in FIGS. 5 and 6, in the surface 203 of the relay terminal 2, the front ends of the first plate 21 and the second plate 22 are positioned frontmost, and the front ends of the third plate 23 and the fifth plate 25 are positioned rearward therefrom. The front end of the fourth plate 24 is positioned on the rear-end side of the surface 203. Protrusions are formed on the front ends of the first plate 21 and the second plate 22 so as to face toward the inside, and protrusions are formed on the front ends of the third plate 23 and the fifth plate 25 so as to face toward the inside. Rectangular apertures 211, 221, 231, and 251 are formed in the respective protrusions. A rectangular aperture 241 is formed in the front end of the fourth plate 24. These apertures 211, 221, 231, 241, and 251 are provided at positions corresponding to the terminal part 34 of the relay 3. The terminals 301 to 305 are inserted into the apertures 211, 221, 231, 241, 251, respectively, and are attached to them with solder. These protrusions and apertures constitute the connection part with the relay 3.

With the above structures, the relay terminal 2 stably holds the relay 3 in a cantilever manner on the surface 203. Furthermore, since the first through fifth plates extend across three mutually orthogonal planes, the plates 21 to 25 can be lengthened, whereby the attenuation of the operation noise can be enhanced.

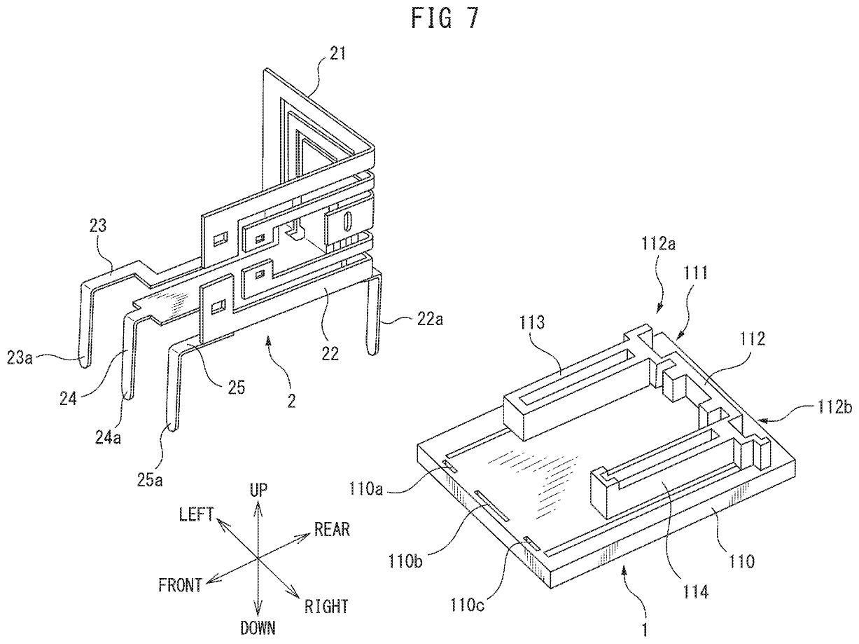

FIG. 7 is an enlarged view of the relay terminal 2 and the base 1. As illustrated in FIG. 7, the base 1 is an integrally molded resin part, and includes a rectangular base plate 110 and a U-shaped projection 111 which is formed so as to project from the base plate 110. The projection 111 includes a rectangular first projection 112 which extends in the left-right directions on the rear end of the base plate 110, and a pair of rectangular left and right second projections 113 and 114 which extend frontward from the left and right ends of the front surface of the first projection 112. At the left and right ends of the first projection 112, recesses 112a and 112b are formed toward the front side, and slit-like through-holes are formed in the bottom surfaces of the recesses 112a and 112b. Furthermore, three slit-like through-holes 110a, 110b, and 110c are formed laterally in a side-by-side manner in the front end of the base plate 110.

Among the five electrode terminals 21a, 22a, 23a, 24a, and 25a, the electrode terminals 21a, 22a are inserted into the through-holes in the bottom surfaces of the recesses 112a and 112b, respectively, and the electrode terminals 23a, 24a, and 25a are inserted into the through-holes 110a, 110b, and 110c, respectively. At this time, the base portions of the electrode terminals 21a and 22a are fitted into the recesses 112a and 112b, respectively. As a result, the relay terminal 2 can be tightly assembled with the base 1. In the state in which the relay terminal 2 is assembled with the base 1, the electrodes on the bottom surface 201 of the relay terminal 2 closely contacts the upper surface of the base plate 1, and the electrodes 23b and 25b rearward of the third terminal electrode 23 and fifth electrode 25 in the bottom surface 201 are positioned along the inside surfaces of the second projections 113, 114.

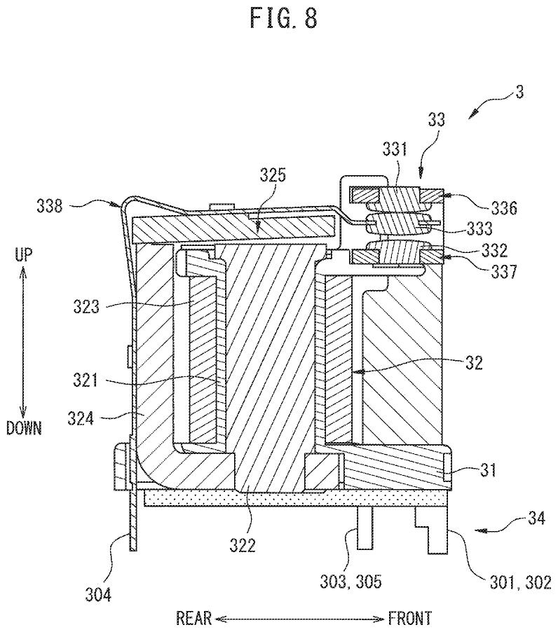

Next, the structure of the relay 3 will be described with reference to FIG. 8. FIG. 8 is a longitudinal sectional view illustrating the relay 3. The relay is not limited to the configuration illustrated in FIG. 8. In FIG. 8, for ease of explanation, the relay cover 310 has been omitted. The relay 3 includes a base block 31, an electromagnet 32 supported by the base block 31, a contact 33 which opens and closes in accordance with the operation of the electromagnet 32, and the terminal 34 which projects from the end surface of the base block 31, and has a rectangular parallelepiped shape as a whole. The base block 31 is an electrically insulating resin molded article which forms the base of the relay 3. In the present embodiment, the relay 3 is arranged sideways, and the bottom surface of the base block 31 is arranged so as to face the surface 203 of the relay terminal 2. The relay cover 310 has a box-like shape having an open bottom surface, and the periphery of the bottom surface thereof is adhered to the base block 31. The relay cover 310 and the base block 31 constitute the housing of the relay 3.

As illustrated in FIG. 8, the electromagnet 32 includes a hollow spool 321 provided on the base block 31, an iron core 322 accommodated inside the spool 321, and a coil 323 wound on the periphery of the spool 321. The ends of the winding of the coil 323 are connected to a pair of coil terminals 303, 305, and the terminals 303, 305 project downward through the base block 31. A yoke 324 is fixedly connected to the lower end of the iron core 322. The yoke 324 is, for example, a rigid plate formed from magnetic steel so as to have an L-shaped cross-section. The yoke 324 extends on the rear side of the coil 323, and an armature 325 is supported on an upper end of the yoke 324 so as to be swingable in the up-down directions. The armature 325 is a rigid plate formed from, for example, magnetic steel, and is elastically and movably supported relative to the yoke 324 via a movable spring 338, which is provided in the contact 33. When the electromagnet 32 operates, a magnetic circuit is formed between the iron core 322, the yoke 324, and the armature 325.

The contact 33 comprises a first fixed terminal 336 and a second fixed terminal 337, which are spaced in the up-down directions, and the movable spring 338 which is arranged between the first fixed terminal 336 and the second fixed terminal 337. A first fixed contact 331 and a second fixed contact 332 project from the lower surface of the distal end of the first terminal 336 and the upper surface of the distal end of the second fixed terminal 332, respectively, and movable contacts 333 project from the upper and lower surfaces of the distal end of the movable spring 338.

As illustrated in FIG. 8, the first fixed terminal 336 and the second fixed terminal 337 are constituted by L-shaped plates which extend toward the base block 31, and the terminals 301, 302, which extend beyond the base block 31, for the fixed terminals are formed on the distal ends thereof, respectively. As illustrated in FIG. 8, the movable spring 338 penetrates the base block 31 through the back of the yoke 324, and a terminal 304 for the movable terminal is formed on the distal end thereof. The above terminals 301, 302, terminal 304, and terminals 303 and 305 constitute the terminal 34. The terminals 301 to 305 correspond to the positions of the apertures 211, 221, 231, 241, and 251 of the relay terminal 2.

The outer cover 5 has a box-like shape with an open bottom surface, and is formed by resin molding. The shape of the bottom surface of the outer cover 5 is substantially equal to the outer shape of the base 1, and the base 1 can be attached to the inner surface of the outer cover 5. The outer cover 5 and the base 1 constitute the housing of the electromagnetic relay 100.

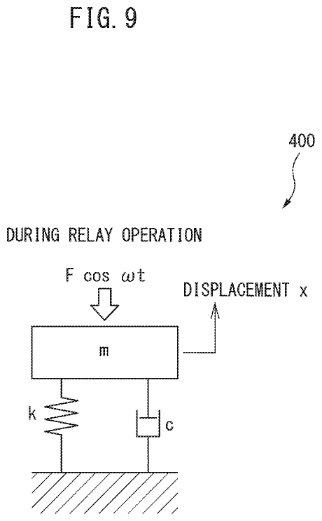

The theory regarding the reduction of vibration sounds and the like as a result of the use of a weight 4 will be described. It is assumed that the model 400 illustrated in FIG. 9 is a vibration model corresponding to the electromagnetic relay configured such that the relay is assembled with the base via the relay terminal. The reference signs of FIG. 9 have the following meanings.

m=mass of the relay

k=spring constant

c=damping factor

The equation of motion of the model 400 is represented by the following formula (1):

m\ddot{x}(t)+c\dot{x}(t)+k(x)=F cos ωt (1)

In formula (1), the right-hand expression F cos ωt represents the force exerted on the relay during operation of the relay. Assuming that the displacement x corresponding to the force (F cos ωt) exerted on the relay during operation of the relay has the same vibration number (co) as the exerted force, the displacement x is expressed as follows:

x=α cos ωt+b sin ωt (2)

The first and second derivatives of formula (2) are determined and substituted into the equation of motion of formula (1). By developing the substituted formula, the following is obtained:

(−bmω²−αcω+bk)sin ωt+(−αmω²+bcm+ak)cos ωt=F cos ωt (3)

By determining constants a and b of formula (3) and substituting them for a and b in formula (2) of the displacement x, the following particular solution is obtained:

$$x = \frac{F}{m \{ {( {ω}_{n}^{2} - {ω}^{2} )}^{2} + {( \frac{c ω}{m} )}^{2} \}} \{ - \frac{c ω}{m} cos ω t + ( {ω}_{n}^{2} - {ω}^{2} ) sin ω t \}$$

The obtained particular solution is represented by the sum of two simple harmonic oscillations, and the combination of these into one simple harmonic oscillation is expressed as follows:

x=A cos(ωt−Ø)

where A represents amplitude and φ represents phase delay.

The amplitude A can be determined from the following formula (4):

$$A = \frac{F}{\sqrt{{( k - m {ω}^{2} )}^{2} + {( c ω )}^{2}}} \qquad ( 4 )$$

It can be understood from formula (4) that the amplitude A can be reduced by increasing the mass m of the relay, the spring constant k, or the damping factor c.

In the model 400, it can be assumed that the mass m is the weight of the relay 3, the spring constant k is the spring constant of the relay terminal 2, and the damping factor c depends on the material and structure of the relay 3. Since it is necessary to change the shape of the relay terminal 2 if the spring constant k is changed, changing the spring constant k is not considered to be preferable as doing so may bring about a deterioration of the current-carrying performance of the relay terminal 2. Furthermore, changing the damping factor c is problematic since doing so necessitates a change in the material and structure of the relay. Thus, the present embodiment focuses on increasing the weight of the relay 3.

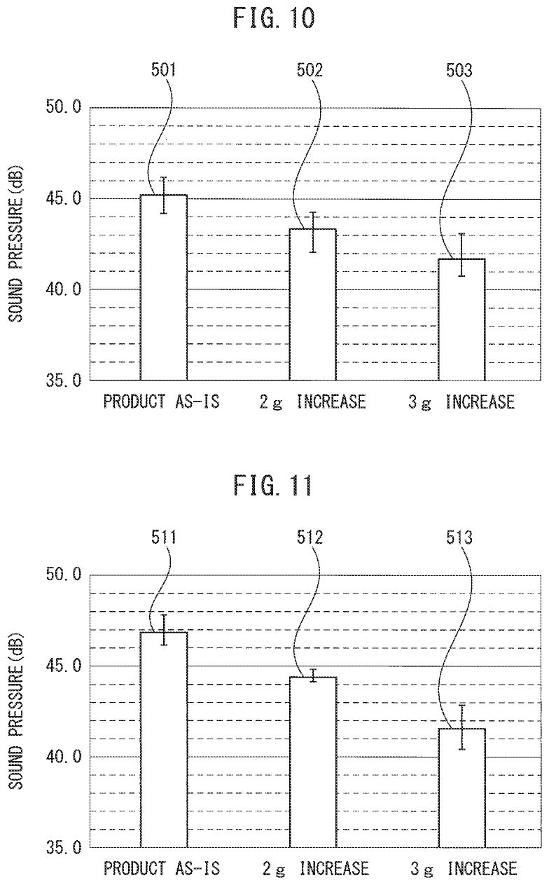

As a comparative example, an electromagnetic relay having a structure which is identical to the electromagnetic relay 100 except that a weight 4 is not used will be assumed. FIG. 10 is a graph showing the operation noise generated when the electromagnet of the relay is turned on, in which the comparative relay (501), the electromagnetic relay 100 (502) comprising a 2 g weight, and the electromagnetic relay 100 (503) comprising a 3 g weight are contrasted. FIG. 11 is a graph illustrating the return noise generated when the electromagnet is turned off, in which the comparative relay (511), the electromagnetic relay 100 (512) comprising a 2 g weight, and the electromagnetic relay 100 (513) comprising a 3 g weight are contrasted. Note that since the addition of weight up to a maximum of 3 g was possible under the condition that the external dimensions of the comparative relay were not changed, FIGS. 10 and 11 illustrate sound pressure measurement values of the electromagnetic relay 100 to which a weight of 3 g has been attached and the electromagnetic relay 100 to which a weight of 2 g has been attached as a reference.

As illustrated in FIGS. 10 and 11, when a 3 g weight was attached, a decrease in operation noise of 3 dB or more and a decrease in return noise of approximately 5 dB could be confirmed.

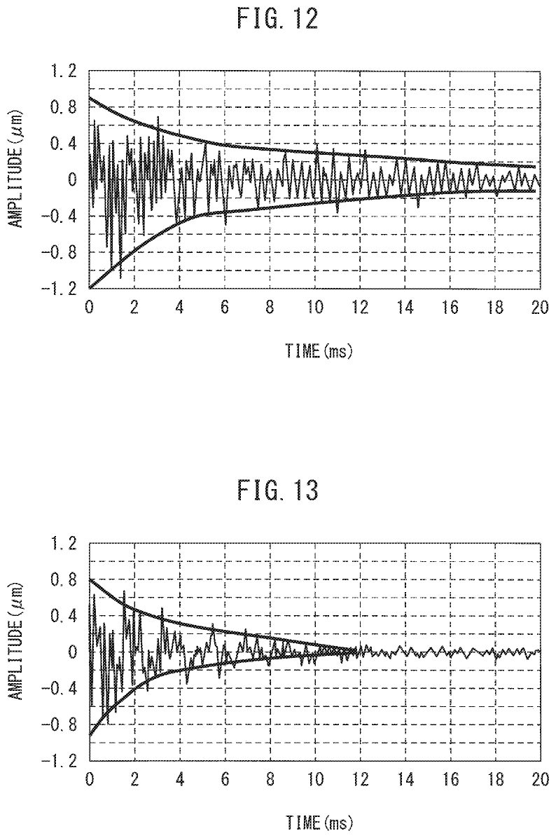

FIG. 12 illustrates the measurement results of the sound pressure waveform of the comparative relay. FIG. 13 illustrates the measurement results of the sound pressure waveform of the electromagnetic relay 100 to which a 3 g weight has been added. In FIGS. 12 and 13, the horizontal axis represents time and the vertical axis represents amplitude. When the sound pressure waveforms of FIGS. 12 and 13 are compared, it can be understood that amplitude was reduced by about 30% and the time for vibration to converge was reduced by about 40% when a weight was added. From the above results, it can be understood that a sound pressure reduction can be achieved by adding a weight.

In light of the above analysis and measurement results, in the present embodiment, a weight 4 is arranged in a gap inside the outer cover 5. Examples of the number, arrangement, shape, etc., of the weight 4 will be described below.

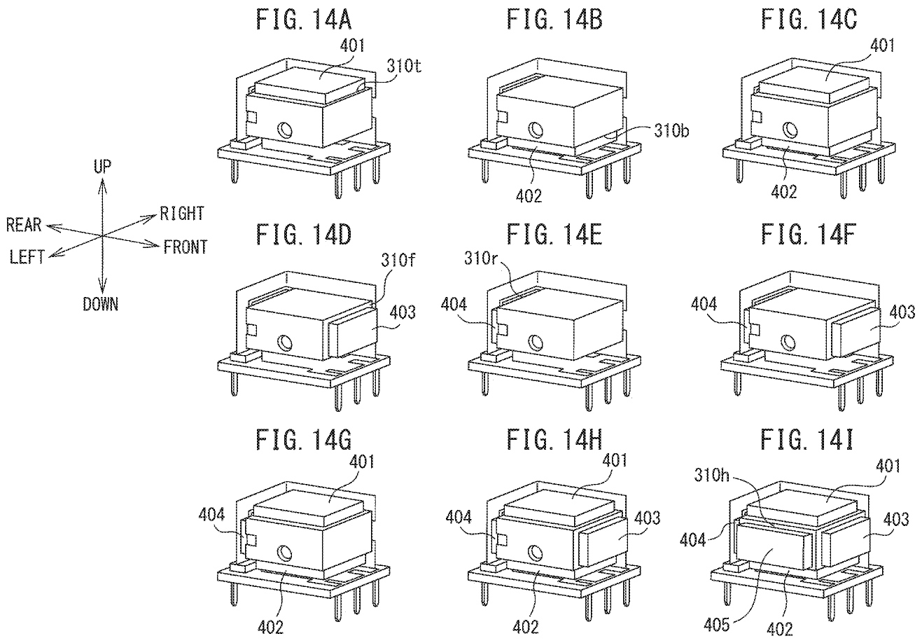

FIGS. 14A to 14I illustrate arrangement examples of the weight 4 in the space inside the outer cover 5. Note that in FIGS. 14A to 14I, though the outer cover 5 has been omitted for convenience of explanation, the weights 4 are arranged so as to not interfere with the outer cover 5. In FIGS. 14A to 14I, the weights 4 are assigned references numerals 401 to 405. FIG. 14A illustrates an example in which a weight 401 is arranged between the upper surface 310t and the inner surface of the outer cover 5. FIG. 14B illustrates an example in which a weight 402 is arranged between the bottom surface 310b and the upper surface of the base 1. FIG. 14C illustrates an example in which the weight 401 and the weight 402 are arranged between the upper surface 310t and the inner surface of the outer cover 5 and between the bottom surface 310b and the upper surface of the base 1, respectively.

FIG. 14D illustrates an example in which a weight 403 is arranged between the front surface 310f and the inner surface of the outer cover 5. FIG. 14E illustrates an example in which a weight 404 is arranged between the rear surface 310r and the inner surface of the outer cover 5. FIG. 14F illustrates an example in which the weight 403 and the weight 404 are arranged between the front surface 310f and the inner surface of the outer cover 5 and between the rear surface 310r and the inner surface of the outer cover 5, respectively. FIG. 14G illustrates an example in which, in addition to FIG. 14C, the weight 404 is arranged between the rear surface 310r and the inner surface of the outer cover 5. FIG. 14H illustrates an example in which, in addition to FIG. 14G, the weight 403 is arranged between the front surface 310f and the inner surface of the outer cover 5. FIG. 14I illustrates an example in which, in addition to FIG. 14H, a weight 405 is arranged between the surface 310h and the inner surface of the outer cover 5. As illustrated, the weight of the relay 3 can be increased by arranging a weight in the free space inside the outer cover 5. Note that, in the examples illustrated in FIGS. 14A to 14I, the weights 401 to 405 can be secured to the outer surface of the relay 3 by bonding or various other fixation manners.

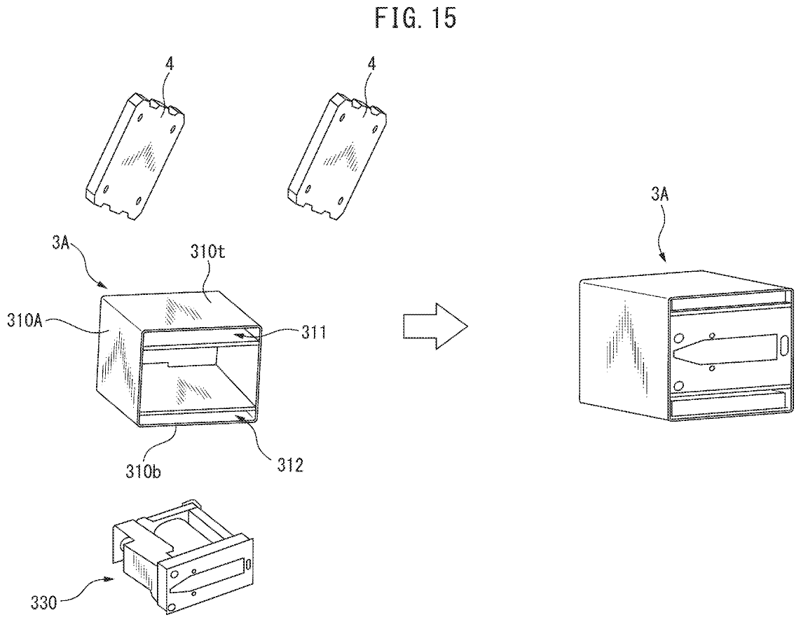

Next, a relay 3A comprising a relay cover 310 to which weights 4 can be attached will be described. FIG. 15 is an exploded view of the relay 3A. In FIG. 15, a pocket 311 for inserting a weight 4 is formed along the upper surface 310t, and a pocket 312 for inserting another weight 4 is formed along the bottom surface 310b in the relay cover 310A. Weights 4 are inserted into the pockets 311, 312 and secured by bonding or another fixation manner. Thereafter, a relay body 330 is inserted into the relay cover 310A, and the relay cover 310A is secured to the relay body 330 using adhesive. As a result, the relay 3A illustrated in FIG. 15 is obtained. According to such a configuration, insulation between the weights 4 and the relay terminal 2 can be reliably ensured.

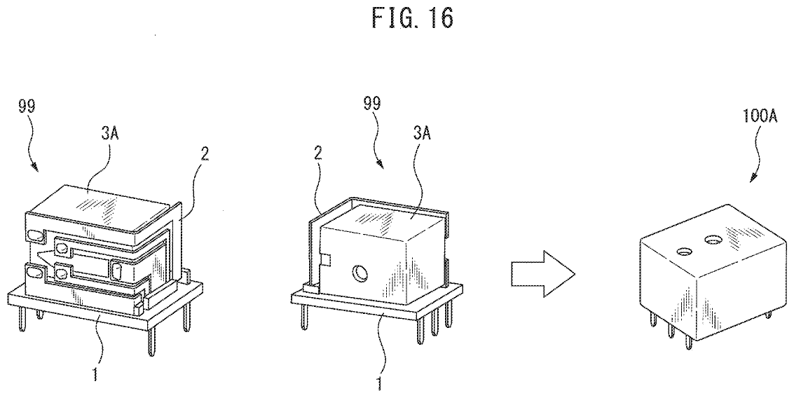

Next, the relay 3A is connected to the relay terminal 2, and the relay terminal 2 is assembled with the base 1. An assembly 99 illustrated in FIG. 16 is produced, and by adhering the outer cover 5 to the assembly 99, the electromagnetic relay 100A illustrated in FIG. 16 is obtained. Note that the left side of FIG. 16 includes two perspective views of the assembly 99 as illustrated from the right side and the left side.

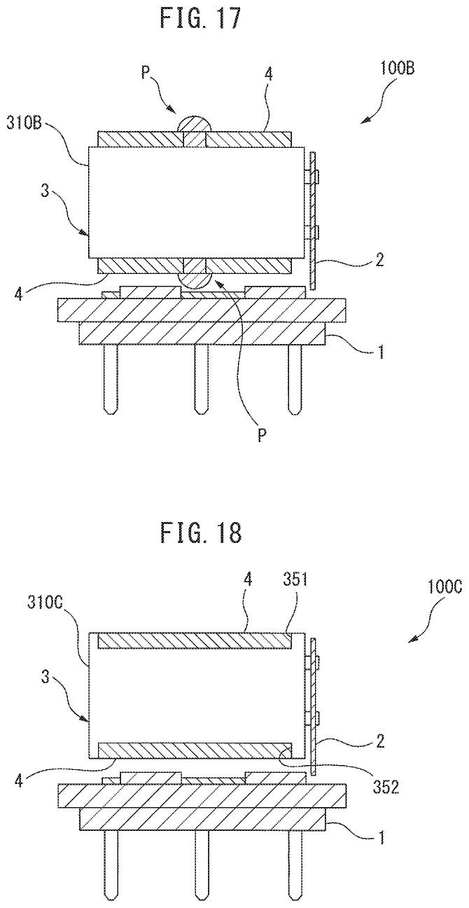

Next, an example for securing the weight 4 to the relay cover 310 will be described. FIG. 17 illustrates an example in which the weight 4 is secured to a relay cover 310B by thermal caulking. FIG. 17 is a cross-sectional view taken along a plane perpendicular to the front-rear directions as viewed from the front side. In the electromagnetic relay 100B, resin protrusions are formed on central portions P of the upper and bottom surfaces of the relay cover 301B, and through-holes are formed in the weights 4 in positions corresponding to the resin protrusions. The weights 4 are assembled with the upper and lower surfaces of the relay cover 310B so that the protrusions penetrate the through-holes. Thereafter, the protrusions protruding to the outside of the through-holes are heated and pressed to perform thermal caulking. This example is advantageous in terms of manufacturability and cost since the weights 4 can be secured by thermal caulking.

FIG. 18 illustrates an example in which a recess for fitting the weight 4 is formed in the outer surface of the relay cover 310C of an electromagnetic relay 100C. FIG. 18 is a cross-sectional view taken along a plane perpendicular to the front-rear directions as viewed from the front side. As illustrated in FIG. 18, recesses 351, 352 for fitting weights 4 are formed in the upper surface and bottom surface of a relay cover 310C, respectively, and weights 4 are fit and secured in the recesses 351, 352. This example is advantageous in terms of manufacturability and cost since the weights 4 can be secured by being fit in the recesses.

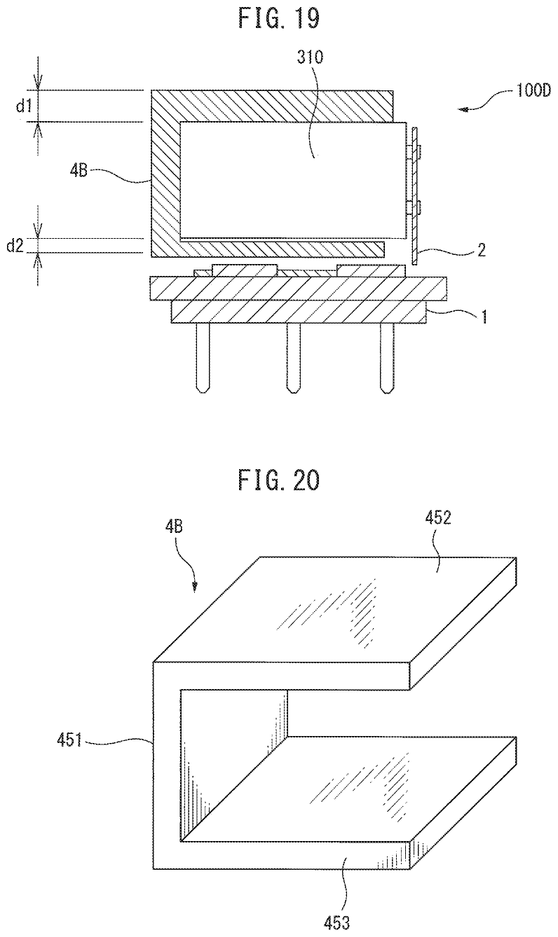

FIG. 19 illustrates an example in which the relay 3 is fit and secured in a weight 4B. FIG. 19 is a cross-sectional view taken along a plane perpendicular to the front-rear directions as viewed from the front side. FIG. 20 illustrates a perspective view of the U-shaped weight 4B. The weight 4B comprises a plate-shaped first portion 451, and a second portion 452 and third portion 453 which are plate-shaped and so as to protrude in the same direction from opposite ends of the first portion 451. The weight 4B is secured to the relay 3 by inserting the relay 3 between the second portion 452 and the third portion 453. Use of this weight 4B is advantageous in terms of manufacturability and cost since the weight 4B can be secured to the relay 3 by simply fitting the relay 3 in the weight 4B. The weight 4B is formed such that the thickness d2 of the lower surface is smaller than the thickness d1 of the upper surface, depending on the height limit of the inside of the electromagnetic relay 100D.

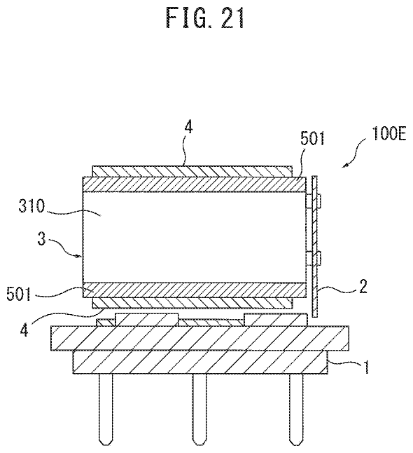

FIG. 21 illustrates an example in which the weights 4 are adhered to the cover 310 of an electromagnetic relay 100E with an epoxy resin adhesive 501. FIG. 21 is a cross-sectional view as viewed from the front side taken along a plane perpendicular to the front-rear directions. In FIG. 21, two weights 4 are adhered to the upper surface and bottom surface of the relay cover 310 with the adhesive 501. This example is advantageous in terms of manufacturability and cost since the weights 4 can be secured to the relay 3 by adhesion with an adhesive.

According to the present embodiment, the weight of the relay can be increased, whereby vibration sounds, impact noise, and vibration of the relay can be controlled, and quietness can be enhanced. That is, an electromagnetic relay which can achieve excellent quietness with a simple configuration and which is excellent in manufacturability can be provided. Furthermore, the present embodiment is advantageous in terms of insulation since the weight is secured to the relay cover.

Though the present invention has been described above using typical embodiments, a person skilled in the art would understand that modifications as well as various other changes, omissions, and additions can be made the embodiments described above without departing from the scope of the invention.

The configurations in which the weights described in the above embodiments are used can be applied to all types of electromagnetic relays configured such that a relay is assembled with a base via a relay terminal and covered with an outer cover.

Though the relay terminal 2 is used as a support member in the embodiments, various types of members can be used as the support member. For example, by using a support member which has the spring constant k illustrated in the model of FIG. 9 for supporting the relay 3, the effects described above in the aforementioned embodiments can be obtained.

The arrangement, number, shape, etc., of the weights are not limited to the examples of the embodiments described above.

A shock absorber may be arranged in the gap inside the outer cover, e.g., in the gap between the relay cover 310 and the base 1.

In the embodiments described above, it is preferable that a material having a high conductivity be used for the relay terminal 2. As a result, the relay terminal 2 can be made thinner, whereby the vibration absorption effect thereof is enhanced. The vibration absorption effect can also be enhanced by using a material having resiliency for the relay terminal 2. In the embodiments described above, the outer cover 5 and the base 1 are adhered with an adhesive. It is preferable that a urethane adhesive be used as the adhesive. A urethane adhesive can similarly be used for the adhesion of other parts, such as the adhesion of the relay cover 310 to the base block 31.

What is claimed is:

1. An electromagnetic relay, comprising:
an relay including an electromagnet, a contact which opens and closes in accordance with operation of the electromagnet, and an inner housing in which the electromagnet and the contact are accommodated;
a support member on which the relay is elastically supported;
an outer housing in which the relay is accommodated; and
a weight which is attached to the relay.

2. The electromagnetic relay according to claim 1, wherein
a pocket or a recess into which the weight is inserted is formed in the inner housing.

3. The electromagnetic relay according to claim 1, wherein the weight has a through-hole, and the weight is secured to an outer surface of the inner housing by heat caulking.

4. The electromagnetic relay according to claim 1, wherein
the weight comprises a plate-shaped first portion, and a plate-shaped second portion and a plate-shaped third portion which are formed so as to protrude in the same direction from opposite ends of the first portion, and
the relay is interposed between the second portion and the third portion of the weight.

5. The electromagnetic relay according to claim 1, wherein the support member is a relay terminal which is electrically connected with the relay, and the relay terminal supports the relay in such a manner that a gap is formed between the outer housing and the relay.
